(19) United States
(12) Patent Application Publication
(10) Pub. No.: US 2015/0085214 A1
(43) Pub. Date: Mar. 26, 2015

(54) LIQUID CRYSTAL LENS AND IMAGE DISPLAY APPARATUS INCLUDING THE SAME

(71) Applicant: PANASONIC CORPORATION, Osaka (JP)

(72) Inventors: Katsuhiko HAYASHI, Nara (JP); Masahiro KASANO, Osaka (JP)

(21) Appl. No.: 14/307,033

(22) Filed: Jun. 17, 2014

(30) Foreign Application Priority Data
Sep. 20, 2013 (JP) 2013-196097
Apr. 8, 2014 (JP) 2014-079431

(51) Int. Cl. G02F 1/1343; G02B 27/22

(52) U.S. Cl. CPC G02F 1/1343; G02B 27/2214
USPC 349/15; 349/139; 349/123

(57) ABSTRACT

A liquid crystal lens according to the present disclosure includes: a first electrode; a plurality of second electrodes arranged in a stripe manner, each second electrode facing the first electrode; a liquid crystal layer provided between the first electrode and the second electrodes, the liquid crystal layer including liquid crystal molecules whose orientation changes in accordance with a voltage applied between the first electrode and the second electrodes, the liquid crystal layer serving as a lens when a refractive index distribution occurs therein due to change in the orientation of the liquid crystal molecules. In the liquid crystal lens, a direction of initial orientation of the liquid crystal molecules is substantially parallel to an extending direction of the second electrodes.

### BACKGROUND

1. Field

The present disclosure relates to a liquid crystal lens and an image display apparatus including the same.

2. Description of the Related Art

A liquid crystal lens is disclosed in Japanese Laid-Open Patent Publication No. 2012-242681.

Japanese Laid-Open Patent Publication No. 2012-242681 discloses a liquid crystal lens that includes a first substrate, a second substrate, and a liquid crystal layer interposed between these substrates and that forms a lens array when an electric field is applied to the liquid crystal layer. The technology described in Japanese Laid-Open Patent Publication No. 2012-242681 improves the response speed of the liquid crystal lens by providing a region having a constant refractive index in a lens portion formed when the electric field is applied.

### SUMMARY

The present disclosure provides a liquid crystal lens that is able to improve light converging performance. In addition, the present disclosure provides an image display apparatus that is able to reduce crosstalk by using the liquid crystal lens.

A liquid crystal lens according to the present disclosure includes: a first electrode; a plurality of second electrodes arranged in a stripe manner, each second electrode facing the first electrode; and a liquid crystal layer provided between the first electrode and the second electrodes, the liquid crystal layer including liquid crystal molecules whose orientation changes in accordance with a voltage applied between the first electrode and the second electrodes, the liquid crystal layer serving as a lens when a refractive index distribution occurs therein due to change in the orientation of the liquid crystal molecule. A direction of initial orientation of the liquid crystal molecules is substantially parallel to an extending direction of the second electrodes.

In addition, an image display apparatus according to the present disclosure includes the above-described liquid crystal lens; an image display panel provided at a back surface side of the liquid crystal lens; and a control section configured to change a voltage applied to the liquid crystal lens such that the voltage is different between in displaying a 2D image and in displaying a 3D image.

The liquid crystal lens according to the present disclosure is effective for improving light converging performance. In addition, the image display apparatus according to the present disclosure is effective for reducing crosstalk.

### BRIEF DESCRIPTION OF THE DRAWINGS

FIG. 1 is a schematic configuration diagram of an image display apparatus according to an embodiment;

FIG. 2 is a diagram showing change in orientation of liquid crystal molecules in the liquid crystal lens according to the embodiment;

FIG. 3 is a diagram showing change in the orientation of the liquid crystal molecules in the liquid crystal lens according to the embodiment;

FIG. 4 is a schematic configuration diagram of a liquid crystal lens according to a comparative example;

FIGS. 5A-C are diagrams explaining a refractive index distribution of a liquid crystal lens according to an example; and

FIGS. 6A-C are diagrams explaining a refractive index distribution of a liquid crystal lens according to a comparative example.

### DETAILED DESCRIPTION

Hereinafter, embodiments will be described in detail with reference to the drawings as appropriate. However, there will be instances in which detailed description beyond what is necessary is omitted. For example, detailed description of subject matter that is previously well-known, as well as redundant description of components that are substantially the same will in some cases be omitted. This is to prevent the following description from being unnecessarily lengthy, in order to facilitate understanding by a person of ordinary skill in the art.

The inventors provide the following description and the accompanying drawings in order to allow a person of ordinary skill in the art to sufficiently understand the present disclosure, and the description and the drawings are not intended to restrict the subject matter of the scope of the patent claims.

### Embodiment

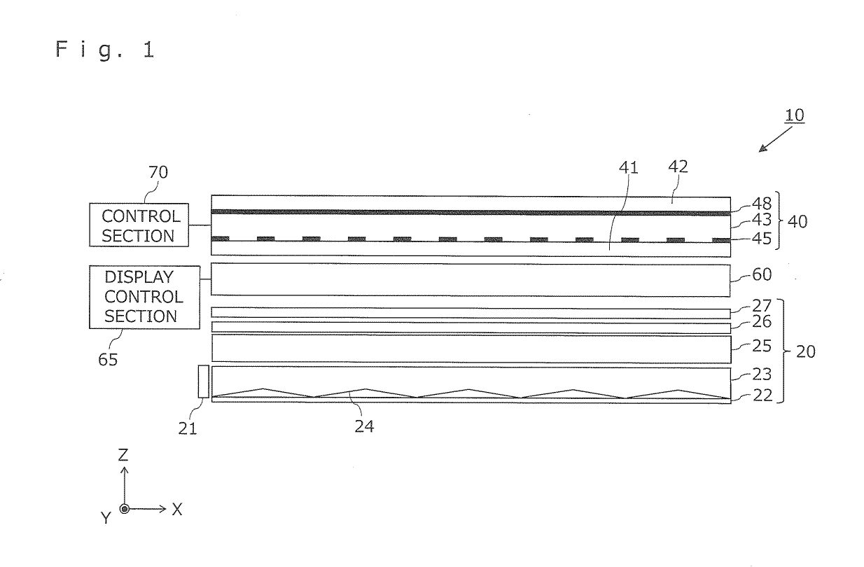

Hereinafter, an embodiment will be described with reference to FIGS. 1 to 4.

[1. Configuration]

FIG. 1 is a schematic cross-sectional view of an image display apparatus 10 according to the embodiment.

In the present embodiment, a three-dimensional orthogonal coordinate system is set for the image display apparatus 10, and a direction is specified by using the coordinate axes. As shown in FIG. 1, an X axis direction coincides with a right-left direction (horizontal direction) when a viewer directly faces a display surface of an image display panel 60. A Y axis direction coincides with an up-down direction when the viewer directly faces the display surface of the image display panel 60. A Z axis direction coincides with a direction perpendicular to the display surface of the image display panel 60. Here, “directly facing” means that the viewer is located directly in front of the display surface such that, for example, when a letter of “A” is displayed on the display surface, the viewer sees the letter of “A” from a correct direction. In addition, FIG. 1 corresponds to a view as seen from above the image display apparatus 10. Thus, the left side in FIG. 1 corresponds to the right side of the display screen when a viewer sees the display screen.

As shown in FIG. 1, the image display apparatus 10 includes a backlight 20, the image display panel 60, a liquid crystal lens 40, a display control section 65 that controls the image display panel 60, and a control section 70 that controls the liquid crystal lens 40. In addition, substrates 41 and 42 for sealing a liquid crystal layer 43 of the liquid crystal lens 40 are provided at a front surface side and a back surface side of the liquid crystal lens 40, respectively. It should be noted that the liquid crystal lens 40 is an example of an image conversion element. Light emitted from the backlight 20 is incident on the image display panel 60. The light incident on the image display panel 60 is emitted to the liquid crystal lens 40 side.

Hereinafter, each component will be described in detail.

The backlight 20 includes a light source 21, a reflection film 22, a light guide plate 23 having inclined surfaces 24, a diffusion sheet 25, a prism sheet 26, and a polarization reflection sheet 27. The reflection film 22 is provided at a back surface side (a lower surface side in FIG. 1) of the light guide plate 23, and the diffusion sheet 25 is provided at a front surface side (an upper surface side in FIG. 1) of the light guide plate 23.

The light source 21 is disposed along one side surface of the light guide plate 23. The light source 21 includes, for example, a plurality of LED elements arranged in the Y axis direction.

Light emitted from the light source 21 spreads within the light guide plate 23 while being repeatedly totally reflected at the front surface and the back surface of the light guide plate 23. Light having an angle surpassing the total reflection angle within the light guide plate 23 is emitted from the front surface of the light guide plate 23. A plurality of inclined surfaces 24 are provided at the back surface of the light guide plate 23 as shown in FIG. 1. By these inclined surfaces 24, light propagating within the light guide plate 23 is reflected in various directions, and thus the intensity of the light emitted from the light guide plate 23 becomes uniform across the entire front surface.

The reflection film 22 is provided at the back surface side of the light guide plate 23. Light having an angle surpassing the total reflection angles of the inclined surfaces 24 provided at the back surface of the light guide plate 23 is reflected on the reflection film 22, enters the light guide plate 23 again, and is eventually emitted from the front surface. The light emitted from the front surface of the light guide plate 23 is incident on the diffusion sheet 25.

The diffusion sheet 25 is a film-like member having minute projections and recesses provided on its surface, and the thickness thereof is about 0.1 to 0.3 mm. The diffusion sheet 25 is provided in order to further uniformize the intensity of the light emitted from the front surface of the light guide plate 23, in the plane direction. A diffusion plate having a plurality of beads therein may be used instead of the diffusion sheet 25. The diffusion plate is thicker than the diffusion sheet 25, and thus has an effect of spreading light in the plane direction therein. Meanwhile, the diffusion sheet 25 has a small effect of spreading light in the plane direction since the diffusion sheet 25 is thinner than the diffusion plate, but the diffusion sheet 25 is able to scatter light by the projections and the recesses on its surface. In addition, use of the diffusion sheet 25 also allows reduction in the thickness of the image display apparatus 10 in the Z axis direction.

The prism sheet 26 is formed by providing a countless number of minute prism arrays on one surface of a transparent film. The prism sheet 26 reflects some light and transmits the other light. The prism sheet 26 has relatively strong directivity in the normal direction of a flat surface of the prism sheet and converges incident light in the front surface direction of the prism sheet 26. Thus, the prism sheet 26 brightly illuminates in an effective direction with a small amount of light.

The polarization reflection sheet 27 is a member specific to a backlight for a liquid crystal panel, transmits light of a component in a polarization direction that the image display panel 60, which is a liquid crystal panel, transmits (a transmitted and polarized component), and reflects the other components. The reflected light becomes unpolarized when being reflected on another optical member or the reflection film 22 provided on the back surface of the light guide plate 23, and is incident on the polarization reflection sheet 27 again. Of the re-incident light, the transmitted and polarized component passes through the polarization reflection sheet 27. By repeating this, polarized components of the light emitted from the backlight 20 are uniformed as polarized components used effectively in the image display panel 60 and are emitted to the image display panel 60 side.

The image display panel 60 has a plurality of pixels and is able to display a 2D image and a 3D image in accordance with control by the display control section 65. An example of the image display panel 60 is a liquid crystal panel using the In-Plane-Switching mode. It should be noted that a liquid crystal panel of another mode, an organic EL panel, or the like may also be used as the image display panel 60.

When a 3D image is displayed on the image display panel 60, the plurality of pixels are divided into right eye pixels and left eye pixels and used. In displaying the 3D image, the display control section 65 displays a right eye image at the right eye pixels and displays a left eye image at the left eye pixels. In other words, in displaying the 3D image, the right eye image and the left eye image are simultaneously displayed on the image display panel 60. The right eye image displayed at the right eye pixels and the left eye image displayed at the left eye pixels are deflected by the liquid crystal lens 40 and converged on the right eye and the left eye of the viewer, respectively.

Meanwhile, when a 2D image is displayed on the image display panel 60, the display control section 65 displays one 2D image using all the pixels as in the conventional art. At that time, the liquid crystal lens 40 is controlled by the control section 70 so as to not to serve as a lens. Therefore, image light of the 2D image passes through the liquid crystal lens 40 as it is and reaches the eyes of the viewer.

Although not shown, a sheet for uniforming polarization of light is formed on each of the incident surface and the emission surface of the image display panel 60. Here, in the present embodiment, a polarization direction of light emitted from the image display panel 60 is the Y axis direction.

The liquid crystal lens 40 is an optical element that guides image light of a right eye image displayed on the image display panel 60 to the right eye of the viewer and guides image light of a left eye image displayed on the image display panel 60 to the left eye of the viewer in displaying a 3D image. The liquid crystal lens 40 includes a first electrode 48, a plurality of second electrodes 45 arranged in a stripe manner, and the liquid crystal layer 43 provided between flat planes on which the first electrode 48 and the second electrodes 45 are arranged respectively. In the present embodiment, the liquid crystal layer 43 is sealed between the substrate 42 at the front surface side and the substrate 41 at the back surface side. The first electrode 48 is formed on the back surface of the substrate 42, and each second electrode 45 is formed on the front surface of the substrate 41. The liquid crystal lens 40 can be produced by attaching together the substrate 41 on which the plurality of second electrodes 45 have been formed and the substrate 42 on which the first electrode 48 has been formed, such that a liquid crystal is enclosed between the substrates 41 and 42. A first orientation film 38 is formed on the light emission surface of the substrate 41, and a second orientation film 35 is formed on the light incident surface of the substrate 42. The orientation films 35 and 38 orient liquid crystal molecules 49 such that the long axes of the liquid crystal molecules 49 are substantially parallel to the Y axis direction in a state where no voltage is applied to the electrodes 41 and 42. However, the orientation films 35 and 38 may not be provided if the orientation of the liquid crystal molecules 49 can be kept uniform. Glass may be used as the materials of the substrates 41 and 42. The liquid crystal lens 40 will be described in further detail later.

The control section 70 switches a value of a voltage applied to the liquid crystal lens 40 such that the value is different between in displaying a 2D image and in displaying a 3D image. In displaying a 3D image, the control section 70 applies a determined voltage to the liquid crystal layer 43 such that the liquid crystal lens 40 has a lens effect. In addition, in displaying a 2D image, the control section 70 controls a voltage such that the liquid crystal lens 40 does not exert a lens effect. It should be noted that, the manner in which the control section 70 controls the voltage supplied to the liquid crystal lens 40 in displaying a 2D image is set as appropriate in accordance with the orientation characteristics or the like of the liquid crystal molecules 49 of the liquid crystal layer 43. For example, in displaying a 2D image, the control section 70 may not apply a voltage to the liquid crystal lens 40, or may apply to the liquid crystal lens 40 such a voltage that a lens effect is not exerted by the liquid crystal lens 40. By controlling the applied voltage in this manner, in displaying a 2D image, light emitted from the image display panel 60 reaches the eyes of the viewer while the direction of the light is kept unchanged even when the light passes through the liquid crystal lens 40. Meanwhile, in displaying a 3D image, light emitted from the image display panel 60 is deflected by the liquid crystal lens 40 such that light from the right eye pixels is converged on the right eye of the viewer and light from the left eye pixels is converged on the left eye of the viewer.

[2. Details of Liquid Crystal Lens]

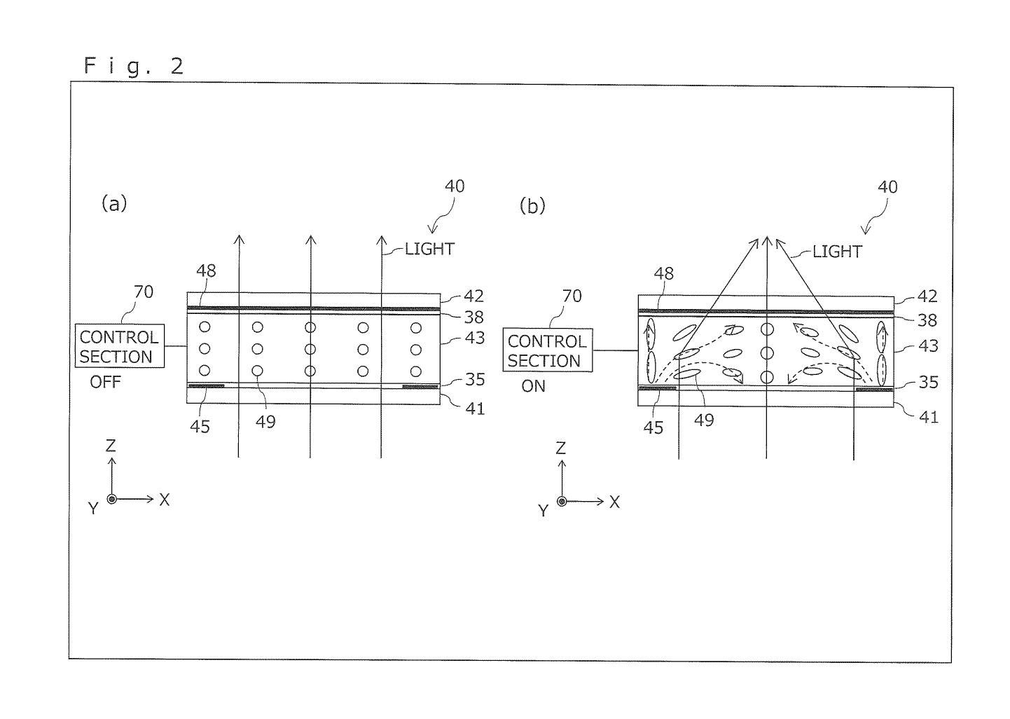

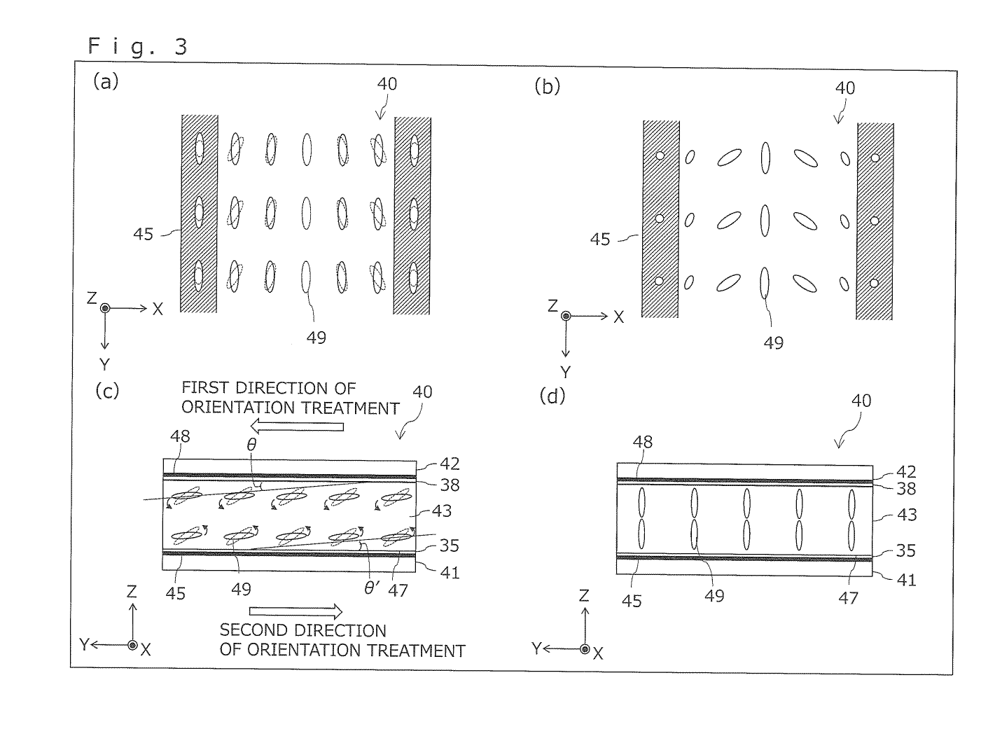

FIGS. 2 and 3 are diagrams showing change in the orientation of the liquid crystal molecules 49 in the liquid crystal lens 40 according to the embodiment. More specifically, (a) and (b) of FIG. 2 are diagrams showing a cross section of the liquid crystal lens 40 that is parallel to an XZ plane, (a) and (b) of FIG. 3 are diagrams showing a cross section of the liquid crystal lens 40 that is parallel to an XY plane, and (c) and (d) of FIG. 3 are diagrams showing a cross section of the liquid crystal lens 40 that is parallel to a YZ plane and an orientation state of the liquid crystal molecules 49 directly above the second electrode 45. In addition, (a) of FIG. 2 and (a) and (c) of FIG. 3 show orientation of the liquid crystal molecules 49 in displaying a 2D image, and (b) of FIG. 2 and (b) and (d) of FIG. 3 show orientation of the liquid crystal molecules 49 in displaying a 3D image. In (a) and (c) of FIG. 3, the orientation of the liquid crystal molecules 49 in displaying a 2D image is shown by solid lines, and a process of the orientation of the liquid crystal molecules 49 being changed when a voltage is applied is shown by broken lines.

As described above, the liquid crystal lens 40 includes the first electrode 48 provided on the inner surface of the substrate 42, the plurality of second electrodes 45 provided on the inner surface of the substrate 41, the liquid crystal layer 43, the first orientation film 38, and the second orientation film 35.

The first electrode 48 is a plane electrode provided on substantially the entirety of the inner surface of the substrate 42. Meanwhile, the plurality of second electrodes 45 are provided on the inner surface of the substrate 41 in a stripe manner (in a slit-like manner) and face the first electrode 48. Each second electrode 45 is a line-shaped electrode extending in the Y axis direction. Each second electrode 45 extends on the front surface of the substrate 41 straight in an extending direction thereof (the Y axis direction). The plurality of second electrodes 45 are arranged so as to be spaced apart from each other at determined intervals in the X axis direction (a direction perpendicular to the extending direction). The first electrode 48 is a transparent electrode, but the second electrodes 45 may be transparent electrodes or may not be transparent electrodes. When a voltage is applied to the liquid crystal lens 40, one lens portion is formed between the second electrodes 45 adjacent to each other in the X axis direction. An arrangement pitch of a plurality of the lens portions formed within the liquid crystal layer 43 when a voltage is applied to the liquid crystal lens 40 is determined by an arrangement pitch of the second electrodes 45 in the X axis direction. It should be noted that it is possible to apply a voltage independently to each of the second electrodes 45.

The liquid crystal lens 40 is an element capable of controlling a distribution of the direction of light passing therethrough in accordance with a voltage applied thereto from the control section 70. Hereinafter, its principle will be described.

First, birefringence will be described. Birefringence is a phenomenon that depending on a state of polarization of incident light, the incident light is split into two rays. The two rays are called ordinary ray and extraordinary ray, respectively. The birefringence An is the difference between ne and no. “ne” is a refractive index for the extraordinary ray and may be referred to as extraordinary ray refractive index. “no” is a refractive index for the ordinary ray and may be referred to as ordinary ray refractive index.

Normally, each liquid crystal molecule 49 has an ellipsoidal shape and has different dielectric constants in the longitudinal direction and the lateral direction thereof. Thus, the liquid crystal layer 43 has a birefringence property in which a refractive index is different for each polarization direction of incident light.

In addition, when the direction of the long axis orientation (director) of each liquid crystal molecule 49 relatively changes with respect to the polarization direction of light, the refractive index of the liquid crystal layer 43 changes. Thus, when the orientation of each liquid crystal is changed by an electric field generated by applying a certain voltage, the refractive index for transmitted light changes. Thus, a lens effect occurs when a voltage is applied with an appropriate electrode configuration.

In the present embodiment, a uniaxial positive type liquid crystal (e.g., positive type nematic liquid crystal) is used as a material for forming the liquid crystal layer 43. Thus, as shown in (a) of FIG. 2, the long axes of the liquid crystal molecules 49 are oriented in the Y axis direction (substantially in the Y axis direction) when no voltage is applied between the first electrode 48 and the second electrodes 45 facing each other.

The polarization direction of light from the image display panel 60 is the Y axis direction. Thus, the refractive index of the liquid crystal layer 43 in the case where no voltage is applied between the first electrode 48 and the second electrodes 45 is uniformly the extraordinary ray refractive index ne.

On the other hand, when a voltage is applied to the liquid crystal lens 40, for example, the potential of the first electrode 48 is set at a ground potential 0 V and the potential of each second electrode 45 is set at V1, thereby applying a voltage V1 higher than a voltage Vth for rising of the liquid crystal, between the first electrode 48 and the second electrodes 45. In this case, as shown in (b) of FIG. 2, the liquid crystal molecules 49 rise near (directly above) the second electrodes 45, so that the long axes of the liquid crystal molecules 49 are oriented in the Z axis direction (the upward direction in FIG. 2). With decreasing distance to the center between the adjacent second electrodes 45, the long axes of the liquid crystal molecules 49 gradually become parallel to the Y axis direction.

The polarization direction of the light from the image display panel 60 is parallel to the Y axis. Thus, the refractive index of the liquid crystal layer 43 for the light emitted from the image display panel 60 is the ordinary ray refractive index no near the second electrodes 45, increases with increasing distance from the second electrodes 45, and becomes nearly the extraordinary ray refractive index ne at the center between the adjacent second electrodes 45. As described above, when a determined voltage is applied to the liquid crystal lens 40, a refractive index distribution (a refractive index distribution in which the refractive index changes in the X axis direction) occurs in the liquid crystal layer 43. A portion of the liquid crystal layer 43 (a portion shown in (b) of FIG. 2) in which the refractive index distribution occurs serves as a lens portion, and deflects light incident thereon in the normal direction of the liquid crystal lens 40, toward the center of the lens portion. It should be noted that since the second electrodes 45 extend in the Y axis direction, the lens portion formed when the voltage is applied has a cylindrical shape.

The control section 70 for the liquid crystal lens 40 does not apply a voltage between the electrodes 45 and 48 as shown in (a) of FIG. 2 in displaying a 2D image. The control section 70 applies a voltage between the electrodes 45 and 48 as shown in (b) of FIG. 2 in displaying a 3D image. With such control, in displaying a 2D image, light incident on the liquid crystal lens 40 passes therethrough as it is without being subject to a lens effect, and in displaying a 3D image, light incident on the liquid crystal lens 40 is converged on the right eye and the left eye of the viewer.

Here, the details of change in the orientation of the liquid crystal molecules 49 in the liquid crystal lens 40 according to the present embodiment will be described with comparison to a comparative example.

The direction of initial orientation of the liquid crystal molecules 49 is substantially parallel to the extending direction of the second electrodes 45. In other words, the liquid crystal molecules 49 are oriented such that the directions of the long axes thereof are substantially parallel to the extending direction of the second electrodes 45. In a state where no voltage is applied between the first electrode 48 and the second electrodes 45 (an applied voltage is 0 V), as shown by sold lines in (a) of FIG. 2 and (a) and (c) of FIG. 3, the liquid crystal molecules 49 are orientated such that the long axes of the liquid crystal molecules 49 are substantially parallel to the extending direction of the second electrodes 45. In other words, the long axes of the liquid crystal molecules 49 lie on the YZ plane and are substantially parallel to the Y axis. The long axes of the liquid crystal molecules 49 extend in parallel along the second electrodes 45. Here, the initial orientation refers to an initial orientation state of the liquid crystal molecules 49 in which the liquid crystal molecules 49 are oriented due to orientation treatment of the orientation films 35 and 38.

Next, when a voltage is applied between the first electrode 48 and the second electrodes 45, the directions of the long axes of the liquid crystal molecules 49 change as shown by broken lines in (a) and (c) of FIG. 3. The change in the orientation of the liquid crystal molecules 49 depends on the positional relationship between the liquid crystal molecules 49 and the second electrodes 45. The liquid crystal molecules 49 directly above the second electrodes 45 rise while rotating about an axis parallel to the X axis as shown in (a) and (c) of FIG. 3. The liquid crystal molecules 49 located at a distance from the second electrodes 45 rise while rotating about an axis parallel to the X axis and also rotating about an axis parallel to the Z axis as shown in (a) of FIG. 3. The rotation angle about the axis parallel to the X axis and the rotation angle about the axis parallel to the Z axis decrease with increasing distances from the second electrodes 45 to the liquid crystal molecules 49 in the X axis direction. At the center between the adjacent second electrodes 45, the orientation of the liquid crystal molecules 49 does not substantially change. As a result, in a state where a voltage is applied between the first electrode 48 and the second electrodes 45, the liquid crystal molecules 49 are oriented as shown in (b) of FIG. 2 and (b) and (d) of FIG. 3. As shown in (d) of FIG. 3, in a state where a voltage is applied, the liquid crystal molecules 49 directly above the second electrodes 45 are oriented such that the long axes thereof are substantially parallel to the Z axis.

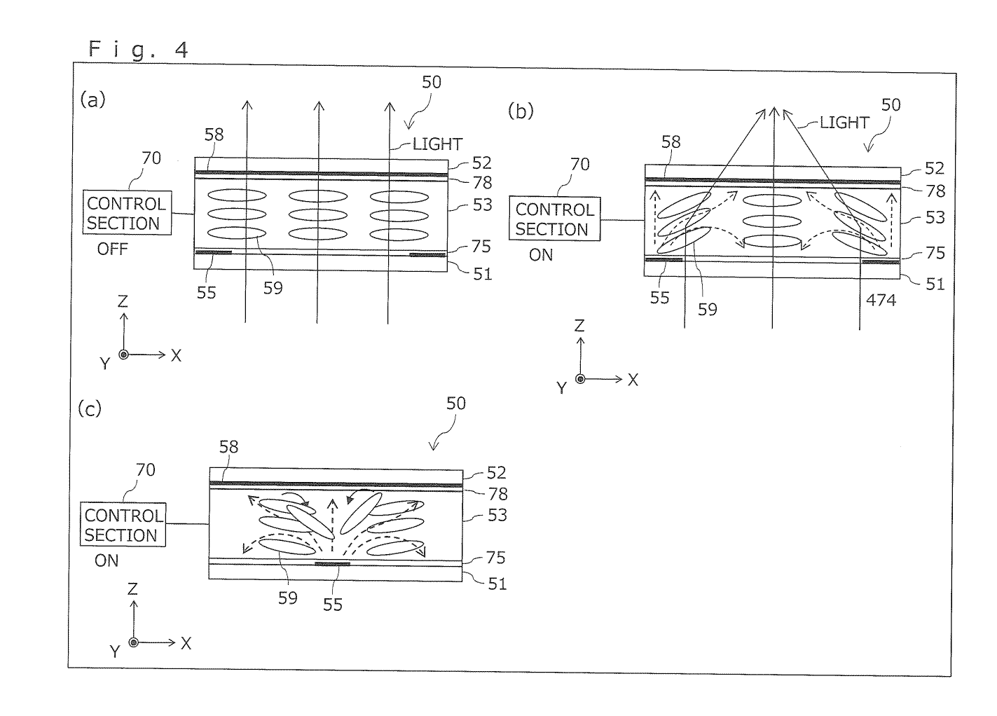

FIG. 4 is a diagram showing change in orientation of liquid crystal molecules 59 in a liquid crystal lens 50 according to the comparative example, and is a diagram showing a cross section corresponding to FIG. 2. More specifically, (a) of FIG. 4 shows orientation of the liquid crystal molecules 59 in a state where no voltage is applied to the liquid crystal lens 50, and (b) of FIG. 4 shows orientation of the liquid crystal molecules 59 in a state where a voltage is applied to the liquid crystal lens 50.

The liquid crystal lens 50 according to the comparative example includes a planar first electrode 58 provided on the inner surface of a substrate 52, a plurality of second electrodes 55 provided on the inner surface of a substrate 51 in a stripe manner, a liquid crystal layer 53 provided between the first electrode 58 and the second electrodes 55, a first orientation film 78, and a second orientation film 75. Similarly to the present embodiment, each second electrode 55 is formed so as to extend in the Y axis direction. It should be noted that in the liquid crystal lens 50 according to the comparative example, in a state where no voltage is applied, as shown in (a) of FIG. 4, the liquid crystal molecules 59 are oriented such that the long axes thereof are orthogonal to the extending direction of the second electrodes 55 (i.e., the long axes thereof are parallel to the X axis direction).

When a voltage is applied between the first electrode 58 and the second electrodes 55, the orientation of the liquid crystal molecules 59 at the center between the adjacent second electrodes 55 does not substantially change, but the liquid crystal molecules 59 at the second electrodes 55 side of the center portion between the adjacent second electrodes 55 rise while rotating about an axis parallel to the Y axis. As a result, the liquid crystal molecules 59 are oriented as shown in (b) of FIG. 4, a refractive index distribution occurs within the liquid crystal layer 53, and a portion of the liquid crystal layer 53 in which the refractive index distribution occurs serves as a lens portion.

However, in the liquid crystal lens 50 in which the liquid crystal molecules 59 are initially oriented in a direction orthogonal to the second electrodes 55 as shown in (a) of FIG. 4, when the liquid crystal molecules 59 rise while rotating about the axis parallel to the Y axis with voltage application, the liquid crystal molecules 59 interfere with each other near the second electrodes 55 as shown in (c) of FIG. 4, thereby causing disorder of the orientation of the liquid crystal molecules 59. As a result, orientation detect of the liquid crystal molecules 59 which is called disclination occurs along the second electrodes 55 extending in the Y axis direction. If disclination occurs when a voltage is applied to the liquid crystal lens 50, aberration of the lens portion formed within the liquid crystal layer 53 increases, and crosstalk deteriorates when a 3D image is displayed on an image display apparatus including the liquid crystal lens 50.

In contrast, in the liquid crystal lens 40 according to the present embodiment, since the liquid crystal molecules 49 are initially oriented so as to be substantially parallel to the second electrodes 45 as shown in (a) of FIG. 2, the liquid crystal molecules 49 directly above and near the second electrodes 45 do not substantially rotate about an axis parallel to the Y axis, and rise by rotating about an axis parallel to the X axis with voltage application. Therefore, when the orientation of the liquid crystal molecules 49 changes, rising of the liquid crystal molecules 49 is less likely to be hindered by other liquid crystal molecules 49 adjacent thereto in the X axis direction, and disorder of the orientation of the liquid crystal molecules 49 directly above and near the second electrodes 45 is suppressed. As a result, in the liquid crystal lens 40 according to the present embodiment, it is possible to reduce occurrence of disclination. Since disclination is reduced in the liquid crystal lens 40, it is possible to suppress deterioration of crosstalk in the image display apparatus 10 including the liquid crystal lens 40.

In addition, in the liquid crystal lens 40 according to the present embodiment, the first orientation film 38 covering the first electrode 48 and the second orientation film 35 covering the second electrodes 45 are provided. It is beneficial that: the first orientation film 38 and the second orientation film 35 are subjected to orientation treatment in a direction parallel to the extending direction of the second electrodes 45; and the direction of the orientation treatment on the first orientation film 38 is opposite to the direction of the orientation treatment on the second orientation film 35. As the orientation treatment, in addition to rubbing, photo-orientation in which light is applied to the orientation films 35 and 38 may be used. In general, liquid crystal molecules are arranged along an orientation treatment direction and tilted so as to rise toward the orientation treatment direction. Liquid crystal molecules being tilted relative to an orientation film in a state where no voltage is applied is referred to as “pre-tilt”, and the angle formed between the long axis of each liquid crystal molecule and the orientation film is referred to as “pre-tilt angle”. When the direction of orientation treatment on the first orientation film 38 at the first electrode 48 side and the direction of orientation treatment on the second orientation film 35 at the second electrodes 45 side are parallel to the extending direction of the second electrodes 45 and opposite to each other, in a state where no voltage is applied, the long axes of the liquid crystal molecules 49 are pre-tilted in substantially the same direction as shown in (c) of FIG. 3. When a voltage is applied, the orientation of the pre-tilted liquid crystal molecules 49 changes in such a direction that the pre-tilt angle is increased. Therefore, when the liquid crystal molecules 49 are pre-tilted as shown in (c) of FIG. 3, the direction of change in the orientation of each liquid crystal molecule 49 (the direction of rotation) when a voltage is applied can be uniform, and it is possible to suppress disorder of the orientation of the liquid crystal molecules 49. In the case where the liquid crystal molecules 49 are not pre-tilted, the direction of change in the orientation of each liquid crystal molecule 49 when a voltage is applied is random and disorder of the orientation of the liquid crystal molecules 49 occurs. Thus, this case is not beneficial. In addition, in the case where the direction of orientation treatment on the first orientation film 38 at the first electrode 48 side and the direction of orientation treatment on the second orientation film 35 at the second electrodes 45 side are parallel to the extending direction of the second electrodes 45 and are the same, the directions in which the long axes of the liquid crystal molecules 49 are pre-tilted are not uniform. Thus, the direction of change in the orientation of the liquid crystal molecules 49 (the direction of rotation) when a voltage is applied is not uniform, and disorder of orientation of the liquid crystal molecules 49 can occur. Due to the above reason, it is beneficial that the direction of orientation treatment on the first orientation film 38 at the first electrode 48 side and the direction of orientation treatment on the second orientation film 35 at the second electrodes 45 side are opposite to each other.

However, due to the above-described reason, when the liquid crystal molecules 49 are initially oriented such that the long axes of the liquid crystal molecules 49 are substantially parallel to the extending direction of the second electrodes 45, it is possible to reduce occurrence of disclination, and thus it is not essential that the direction of orientation treatment on the first orientation film 38 at the first electrode 48 side and the direction of orientation treatment on the second orientation film 35 at the second electrodes 45 side are opposite to each other.

Furthermore, in the case where the liquid crystal molecules 49 are pre-tilted, the pre-tilt angles (θ and θ′ in (c) of FIG. 3) are preferably not lower than 1 degree and not higher than 5 degrees. The pre-tilt angle θ is a tilt angle of the long axis of each liquid crystal molecule 49 relative to the surface, at the liquid crystal layer 43 side, of the first electrode 48 (an included angle between the surface, at the liquid crystal layer 43 side, of the first electrode 48 and each liquid crystal molecule 49). The pre-tilt angle θ′ is a tilt angle of the long axis of each liquid crystal molecule 49 relative to the surface, at the liquid crystal layer 43 side, of each second electrode 45 (an included angle between the surface, at the liquid crystal layer 43 side, of each second electrode 45 and each liquid crystal molecule 49). When the pre-tilt angles θ and θ′ are set within this range, it is possible to suppress disorder of the orientation of the liquid crystal molecules 49 while an amount of change in the refractive index of the liquid crystal layer 43 between before and after voltage application is ensured. In other words, it is possible to realize a liquid crystal lens 40 having a good light conversing property when a voltage is applied while suppressing a reduction in the deflection angle of light of the liquid crystal lens 40 when a voltage is applied. In the case where the pre-tilt angles are less than 1 degree, the direction of change in the orientation of the liquid crystal molecules 49 when a voltage is applied is unlikely to be uniform. In addition, in the case where the pre-tilt angles exceed 5 degrees, a range where the orientation of the liquid crystal molecules 49 is changeable is reduced by voltage application. Thus, an amount of change in the refractive index of the liquid crystal layer 43 between before and after voltage application is also decreased, leading to a reduction in the deflection angle of the liquid crystal lens 40. Therefore, it is beneficial that the pre-tilt angles of the liquid crystal molecules 49 are set within the above range.

[3. Advantageous Effects etc.]

As described above, in the liquid crystal lens 40 according to the present embodiment, when a voltage applied between the first electrode 48 and the second electrodes 45 is 0 V, the liquid crystal molecules 49 are initially oriented such that the long axes of the liquid crystal molecules 49 are substantially parallel to the extending direction of the second electrodes 45. Thus, when a voltage is applied between the first electrode 48 and the second electrodes 45 to change the orientation of the liquid crystal molecules 49, mutual interference between the liquid crystal molecules 49 is suppressed. Therefore, disorder of the refractive index distribution within the liquid crystal layer 43 is suppressed when the voltage is applied, and thus it is possible to reduce aberration when the liquid crystal lens 40 serves as a lens, thereby improving the light converging performance of the liquid crystal lens 40.

In addition, when the long axes of the liquid crystal molecules 49 are pre-tilted in the same direction as shown in (c) of FIG. 3, it is possible to uniformize the direction in which the orientation of the liquid crystal molecules 49 changes when a voltage is applied. Thus, it is possible to further suppress disorder of the orientation of the liquid crystal molecules 49, thereby further improving the light converging performance of the liquid crystal lens 40.

### Other Modifications

The embodiments have been described above as an illustrative example of the technology disclosed in the present application. However, the technology in the present disclosure is not limited thereto, and is also applicable to embodiments in which changes, substitutions, additions, omissions, and/or the like are made as appropriate. In addition, each constituent element described in the above embodiments can be combined to provide a new embodiment.

Other embodiments will be described below.

In the above embodiment, the image display apparatus 10 which includes the image display panel 60 and the backlight 20 is taken as an example. However, in the case where a panel capable of emitting light by itself such as an organic EL panel is used as the image display panel 60, the backlight 20 may not be provided.

In addition, in (c) of FIG. 3, the case has been described where the direction of orientation treatment on the first orientation film 38 at the first electrode 48 side is a Y axis positive direction and the direction of orientation treatment on the second orientation film 35 at the second electrodes 45 side is a Y axis negative direction. However, the arrows in (c) of FIG. 3 may be reversed, the direction of orientation treatment on the first orientation film 38 at the first electrode 48 side may be the Y axis negative direction, and the direction of orientation treatment on the second orientation film 35 at the second electrodes 45 side may be the Y axis positive direction.

As presented above, the embodiments have been described as an example of the technology according to the present disclosure. For this purpose, the accompanying drawings and the detailed description are provided.

Therefore, components in the accompanying drawings and the detail description may include not only components essential for solving problems, but also components that are provided to illustrate the above described technology and are not essential for solving problems. Therefore, such inessential components should not be readily construed as being essential based on the fact that such inessential components are shown in the accompanying drawings or mentioned in the detailed description.

Further, the above described embodiments have been described to exemplify the technology according to the present disclosure, and therefore, various modifications, replacements, additions, and omissions may be made within the scope of the claims and the scope of the equivalents thereof.

### EXAMPLES

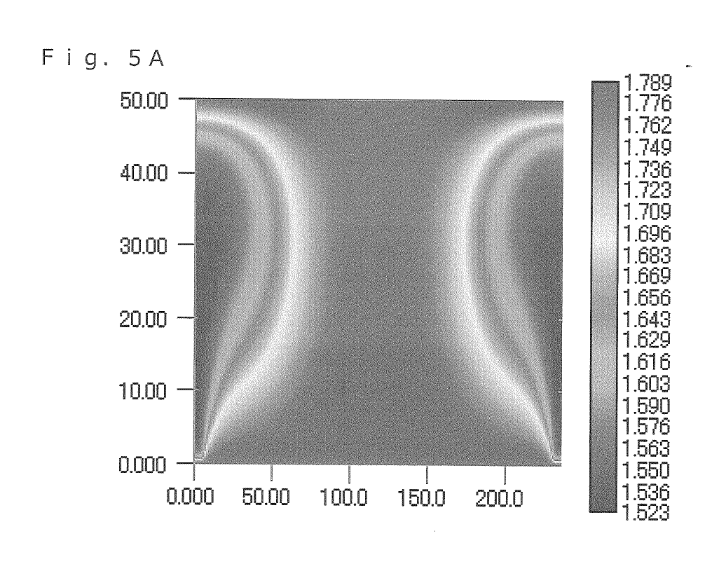

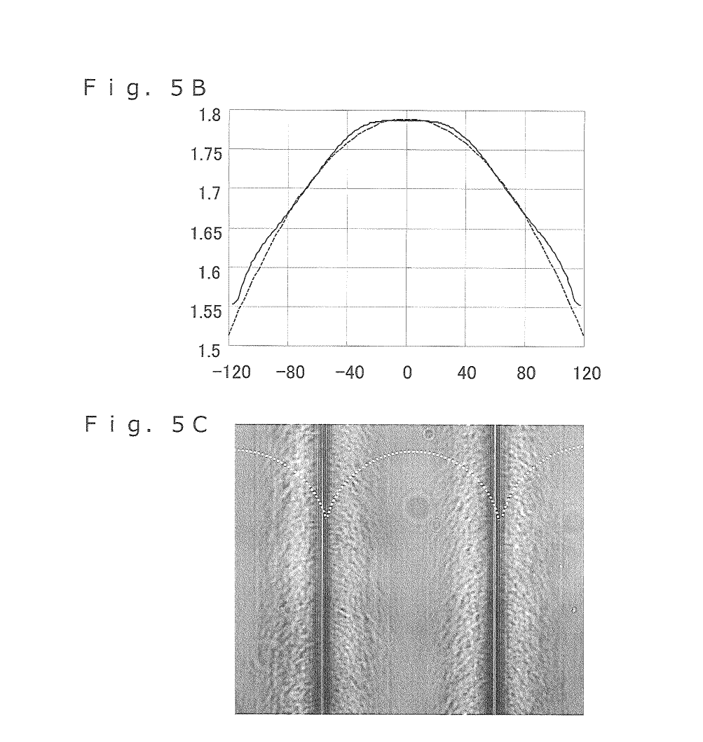

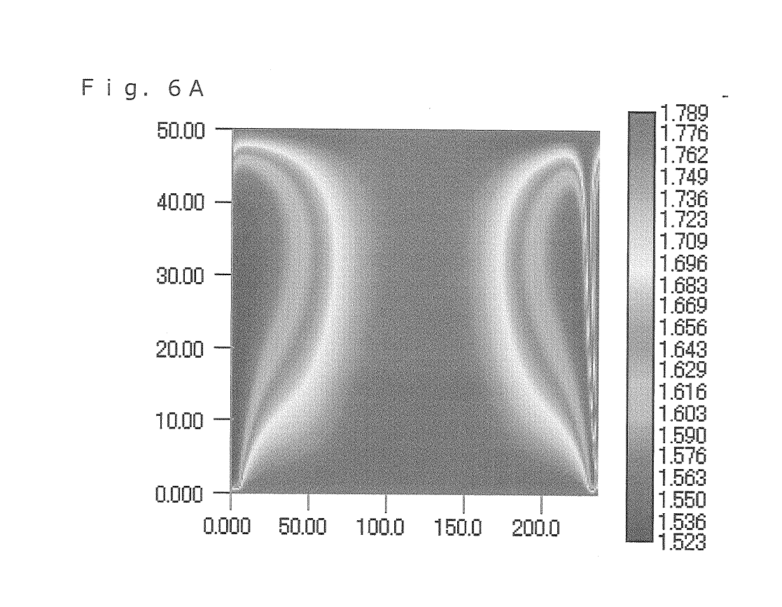

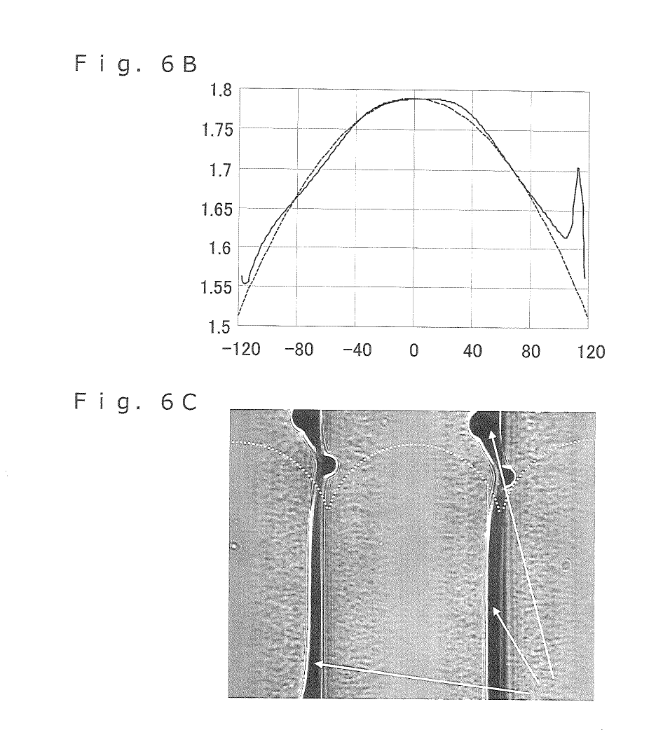

FIG. 5 is a diagram explaining a refractive index distribution of a liquid crystal lens according to an example, and FIG. 6 is a diagram explaining a refractive index distribution of a liquid crystal lens according to a comparative example. Hereinafter, the results of evaluation of the liquid crystal lenses according to the above-described embodiment and comparative example will be described with reference to FIGS. 5 and 6. First, items of the evaluation will be described.

(Refractive Index Distribution within Liquid Crystal Layer)

Each of FIG. 5A and FIG. 6A is a schematic diagram showing, with shading, a refractive index distribution which occurs within the liquid crystal layer when a voltage is applied to the liquid crystal lens according to the example or comparative example and is obtained by simulation.

The conditions of the simulation are as follows.

Pitch of lens portions of liquid crystal lens (pitch of second electrodes): 236 μm

Width of each second electrode: 5 μm

Clearance between substrates (cell gap): 50 μm

Extraordinary ray refractive index ne of liquid crystal layer (liquid crystal material): 1.789, ordinary ray refractive index no thereof: 1.523 (note that refractive indexes for light having a wavelength of 550 nm)

Liquid crystal orientation simulation using the finite element method is performed by using the parameters shown above. In the simulation, the direction of a director at each position in the liquid crystal layer is obtained. The refractive index at each position in the liquid crystal layer is calculated by Mathematical Formula 1 on the basis of this information.

$$n ( θ ) = \frac{{n}_{e} \cdot {n}_{o}}{\sqrt{{n}_{e}^{2} \cdot {sin}^{2} θ + {n}_{o}^{2} \cdot {cos}^{2} θ}} \qquad [ Math . 1 ]$$

Here, θ is an angle at which liquid crystal rises when a voltage is applied, namely, an angle formed between the XY plane and the director.

(Average Refractive Index Distribution within Liquid Crystal Layer)

FIG. 5B is a graph showing an average refractive index distribution of an ideal refractive index distribution lens and an average refractive index distribution of the liquid crystal lens according to the example. In addition, FIG. 6B is a graph showing the average refractive index distribution of the ideal refractive index distribution lens and an average refractive index distribution of the liquid crystal lens according to the comparative example. In FIG. 5B and FIG. 6B, an average refractive index distribution curve of the ideal refractive index distribution lens is shown by a broken line, and average refractive index distribution curves of the liquid crystal lenses according to the example and the comparative example are shown by solid lines. As shown by the broken line, the average refractive index distribution curve of the ideal refractive index distribution lens is a quadratic curve. In addition, in FIG. 5B and FIG. 6B, the horizontal axis indicates a distance (μm) from the center between the adjacent second electrodes, and the vertical axis indicates an average refractive index at a position specified at the horizontal axis.

(Electron Micrograph of Liquid Crystal Layer)

Each FIG. 5C and FIG. 6C is an electron micrograph showing a state of the liquid crystal layer when a voltage is applied to the liquid crystal lens according to the example or the comparative example. Each of FIG. 5C and FIG. 6C corresponds to a state where the liquid crystal lens shown in (b) of FIG. 2 or (b) of FIG. 4 is seen from above in the Z axis direction.

(Results of Evaluation)

As shown in FIG. 5, in the liquid crystal lens according the example, since disorder of the orientation of the liquid crystal molecules is reduced, as shown in FIG. 5A, great disorder does not occur also in the refractive index distribution of the liquid crystal layer. In addition, as shown in FIG. 5B, the average refractive index distribution curve of the liquid crystal lens according to the example is a curve close to the average refractive index distribution curve of the ideal refractive index distribution lens. Furthermore, in the electron micrograph shown in FIG. 5C as well, it is confirmed that occurrence of orientation detect such as disclination is suppressed near the second electrodes (vertical white line portions shown in FIG. 5C).

In contrast, in the liquid crystal lens according to the comparative example, as shown in FIG. 6A and FIG. 6B, near the second electrodes, disorder of the refractive index distribution of the liquid crystal layer occurs, and the average refractive index distribution curve greatly deviates from the ideal curve. In addition, in the electron micrograph shown in FIG. 6C, as shown by arrows, it is confirmed that disclination remarkably occurs near the second electrodes.

From the above-described results of evaluation, according to the liquid crystal lens according to the example, it is confirmed that since it is possible to reduce disorder of the refractive index distribution within the liquid crystal layer when a voltage is applied, it is possible to realize a liquid crystal lens that has less aberration when a lens function is exerted and that has good light converging performance.

What is claimed is:

1. A liquid crystal lens comprising:
a first electrode;
a plurality of second electrodes arranged in a stripe manner, each second electrode facing the first electrode; and
a liquid crystal layer provided between the first electrode and the second electrodes, the liquid crystal layer including liquid crystal molecules whose orientation changes in accordance with a voltage applied between the first electrode and the second electrodes, the liquid crystal layer serving as a lens when a refractive index distribution occurs therein due to change in the orientation of the liquid crystal molecule, wherein
a direction of initial orientation of the liquid crystal molecules is substantially parallel to an extending direction of the second electrodes.

2. The liquid crystal lens according to claim 1, further comprising:
a first orientation film provided at the first electrode side;
a second orientation film provided at the second electrodes side, wherein
the first orientation film and the second orientation film are subjected to orientation treatment in directions that are parallel to the extending direction of the second electrodes and opposite to each other.

3. The liquid crystal lens according to claim 2, wherein
when no voltage is applied between the first electrode and the second electrodes, long axes of the liquid crystal molecules are tilted relative to a surface, at the liquid crystal layer side, of the first electrode, and
a tilt angle of the long axis of each liquid crystal molecule relative to the surface, at the liquid crystal layer side, of the first electrode is not lower than 1 degree and not higher than 5 degrees.

4. An image display apparatus comprising:
the liquid crystal lens according to claim 1;
an image display panel provided at a back surface side of the liquid crystal lens; and
a control section configured to change a voltage applied to the liquid crystal lens such that the voltage is different between in displaying a 2D image and in displaying a 3D image.
